(19) United States
(12) Patent Application Publication
(10) Pub. No.: US 2017/0105559 A1
(43) Pub. Date: Apr. 20, 2017

(54) SANITARY DRINKING STRAW DISPENSING ASSEMBLY

(71) Applicant: Terence K. Watson, Grand Rapids, MN (US)

(72) Inventor: Terence K. Watson, Grand Rapids, MN (US)

(21) Appl. No.: 15/295,499

(22) Filed: Oct. 17, 2016

Related U.S. Application Data
(60) Provisional application No. 62/242,607, filed on Oct. 16, 2015.

(51) Int. Cl. A47G 19/30; B65D 75/58; B65D 65/22; B65D 83/02; B65D 25/24

(52) U.S. Cl. CPC A47G 21/184; B65D 83/02; B65D 25/24; B65D 65/22; B65D 75/5833; F16B 47/00

(57) ABSTRACT

A sanitary drinking straw dispensing assembly comprising a plurality of drinking straws each supported in an individual sanitized wrapper or covering to protect the straw free of dirt and contamination with the sanitized wrappers each having a first end, a second end and a fingertip grasping tear-away section located proximal the second end of the sanitized wrappers, and a container supporting at least a portion of the wrapped straws proximal the first end of the sanitized wrappers therein with the sanitized wrappers bounded to each other proximal the second end of the sanitized wrappers within the container.

### FIELD OF THE INVENTION

This invention relates generally to drinking straw dispensers and, more specifically to a sanitary drinking straw dispenser to reduce contamination and sanitary related issues due to improper handling of drinking straws.

### CROSS REFERENCE TO RELATED APPLICATIONS

This application claims priority to currently pending U.S. Provisional Application Ser. No. 62/242,607; filed on Oct. 16, 2015; titled SANITARY DRINKING STRAW DISPENSING ASSEMBLY.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

Drinking straws are well known in the art and are used for drinking fluids from a beverage container without the user's lips having to touch any portion of the beverage container. At commercial food establishments that serve food and drink such as diners, restaurants, bars, etc. . . . drinking straws are supported in dispensers or containers at counters, and at individual tables or booths. When a patron selects a drinking straw for their own use, the patron does not know whether the straw that he or she selected has already been bacterially contaminated by prior patrons or by a food and/or drink establishment employee as a result of the employee's handling of the straws during the replenishing process of the straw dispensers or containers. This is true whether or not the drinking straws are uncovered or are enclosed in a paper or plastic wrapping.

For example, patrons such as children have been known to playfully rummage their hands, which may or may not be cleaned, through the straws, which may be covered or uncovered, in the dispenser or container. Food and/or drink establishment employees have been known to lazily or out of convenience ignore proper sanitary protocols and restock the drinking straw dispensers or containers with drinking straws that have been mishandled or wastefully dispensed by prior patrons. These drinking straws may at times have fallen to the ground, or elsewhere, thus leading to further contamination, which can be imparted to the user or patron.

There thus is a need for a sanitary drinking straw dispenser that reduces, and may eliminate, contamination and sanitary related issues due to improper handling of drinking straws by both prior patrons and by food and/or drink establishment employees who overlook proper sanitary protocols.

Food and/or drink establishments conventionally provide accessible containers or dispensers of numbers of drinking straws, which may be individually enclosed in a protective covering which the patron or user tears away to get to the straw or may be uncovered. As mentioned earlier, it is quite possible, if not likely, that the protective coverings on covered straws themselves are contaminated which the unsuspecting user is not aware of. The present invention seeks to significantly reduce, if not totally eliminate, any significant transfer of any contamination in this manner while still providing patrons with the same type of a dispenser of covered drinking straws with which the establishments and the patrons are familiar.

### SUMMARY OF THE INVENTION

The present invention utilizes a relatively stiff box-like container quite similar to a conventional drinking straw dispenser with a multiplicity of straws, each of which is enclosed in a somewhat loose frangible paper covering or wrapping, closely stacked together longitudinally with an end located at an opening of the container for grasping by a patron or user to remove a straw. Within the container the covered straws are bound together and are bonded to the container in a suitable fashion. When a patron, or other, grasps the exposed end of a covered straw and pulls it out of the container the cover separates and at least in part remains within the container. The coverings remaining in the container obstruct any attempt to insert any covered or uncovered replacement straws into the container. An embodiment of the invention provides a circumferential tear line on the covering to assure separation when a straw is removed in the described manner.

### BRIEF DESCRIPTION OF THE DRAWINGS

FIG. 1 is a side view showing an embodiment of the sanitary drinking straw dispenser having a suction-cup stand;

FIG. 2 is a side view showing a sanitary drinking straw dispenser for dispensing at an angle condition with respect to a support surface;

FIG. 3 is a partial cross-section side view showing a sanitary drinking straw dispenser that includes a flexible elongated arm stand with a weighted base; and

FIG. 4 is a partial cross-sectional view showing a sanitary drinking straw dispenser that includes a flexible elongated arm stand with a weighted base.

### DESCRIPTION OF THE PREFERRED EMBODIMENT

The present invention relates to sanitary drinking straw dispensers and dispensing assemblies used to reduce contamination and sanitary related issues due to improper handling of drinking straws by both prior patrons and by food and/or drink establishment employees who overlook proper sanitary protocols.

The present invention comprising a plurality of individually wrapped drinking straws having a first end supported within a container such as a dispensing container and a second end located at an accessible opening in the dispensing container.

A feature of the present invention is that at least a portion of the individual sanitized wrapper of the drinking straws proximal the first end of the plurality of individually wrapped drinking straws are bounded together within the dispensing container by a plurality of means including but not limited to various types of fasteners, binding sleeves, non-toxic adhesives, and the combination such that removal of a drinking straw from the dispensing container requires the tearing of the wrapped-covering of the drinking straw with a portion of the wrapped-covering of the drinking straw being left supported within the dispensing container.

Another feature of the present invention is that once bounded together additional individually wrapped drinking straws cannot be added to the dispensing container thereby eliminating the restocking of potentially contaminated or mishandled drinking straws into the dispenser.

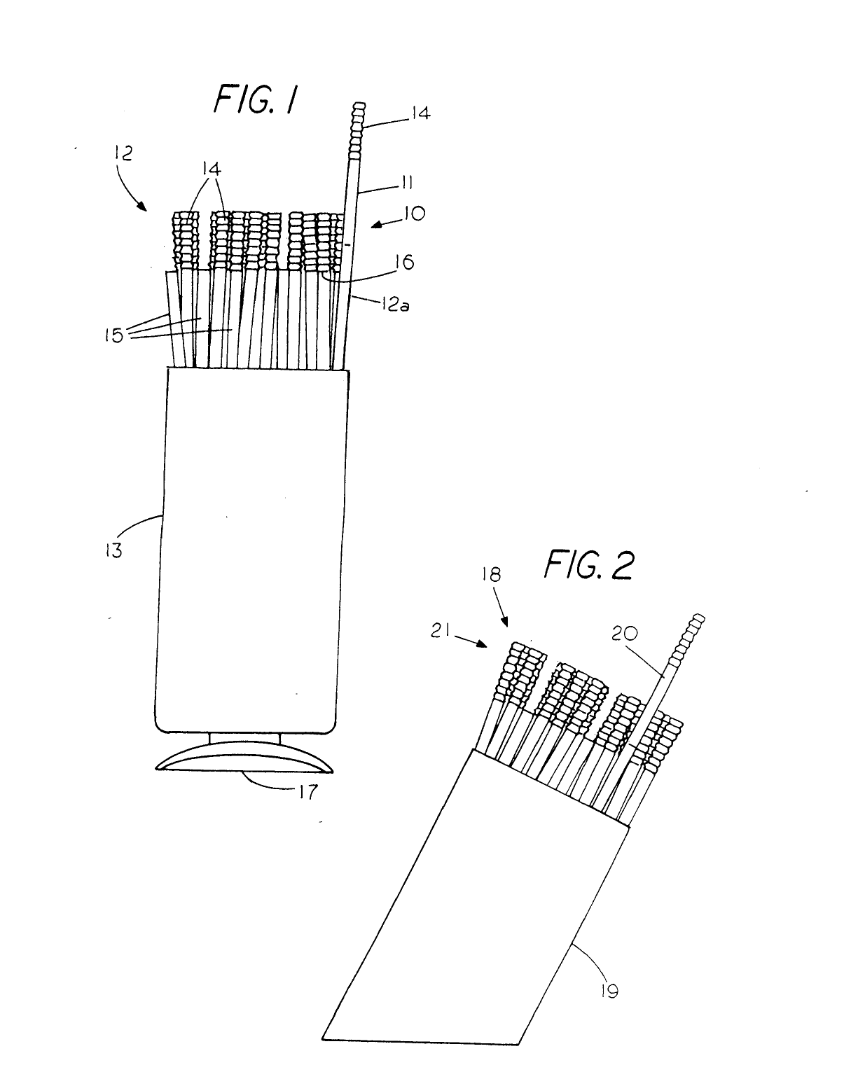

Referring to the drawings, FIG. 1 is a side view showing an embodiment a sanitary drinking straw dispensing assembly 10 of the present invention comprising a plurality of drinking straws 11 each enclosed in an individually sanitized wrapper 12. The sanitized wrapper 12 of the drinking straw 11 is generally made of paper, plastic or other suitable material and the enclosed drinking straws 11 are generally made of paper, plastic or other suitable material therein.

The sanitized wrapper 12 has an exposed end 12a located outside of the dispensing container 13 and an un-exposed end (not shown) located within the dispensing container 13. Sanitized wrapper 12 functions to protect the drinking straw 11 against exposure to dust, dirt, and bacterial contamination.

In the embodiment of FIG. 1 the exposed end 12a of the sanitized wrapper 12 is shown having a finger-engaging portion 14 that comprises a different color than the remainder portion of the sanitized wrapper 12 to provide the user a visual indicator of where to grasp the drinking straw 11 for dispensing. In use, upon the user's manipulatively grasping appropriately the different colored finger-engaging portion 14 of the sanitized wrapper 12 and longitudinally pulling the sanitized wrapper 12 sufficiently, the sanitized wrapper 12 will separate into two portions, namely the finger-engaging portion 14 that will accompany the exposed drinking straw and empty wrapper portion 15 that will remain supported by the dispensing container 13.

It is noted that some embodiments of the present invention may include a circumferential line of perforations or indentations 16 that is weakened by a fine milled stamp or other suitable pressure sensitive applications in order to provide for a cleaner and anticipated separation point between the finger-engaging portion 14 and the empty wrapper portion 15 of the sanitized wrapper 12 that is left supported by the dispensing container 13.

It is further noted that the plurality of individually wrapped drinking straws are bounded together within the dispensing container 13 in such a manner that removal of one drinking straw 11 to a majority of drinking straws 11 from the dispensing container 13 will not affect the drinking straws 11 remaining in the dispenser container 13. That is, the remaining drinking straws 11 will not fall out or become loosen from the dispensing container 13 due to the fact that the empty wrapper portion 15 of the sanitized wrapper 12 are still supported by the dispensing container 13. The presence the empty wrapper portion 15 in the dispensing container 13 will also prevent the restocking of potentially contaminated or mishandled drinking straws into the dispensing container 13 to ensure to the user that any drinking straw that is dispended from the dispensing container 13 of the present invention is safe to use.

The embodiment of FIG. 1 also shows dispensing container 13 having a suction-cup based stand 17 to help assist dispensing container 13 in maintaining stationary support to a support surface such as a table or countertop surface.

FIG. 2 is a side view showing an alternative embodiment of a drinking straw dispensing assembly 18 of the present invention comprising a dispensing container 19 supporting and dispensing a plurality of drinking straws 20 each enclosed in an individually sanitized wrapper 21 at an angle condition with respect to a support surface.

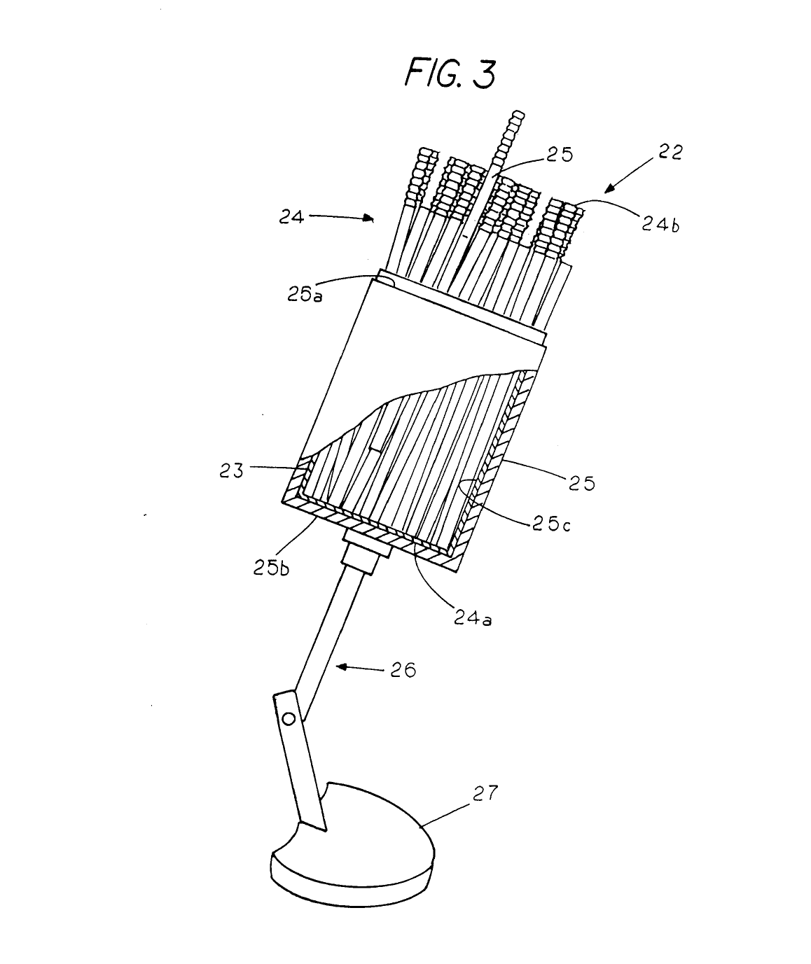

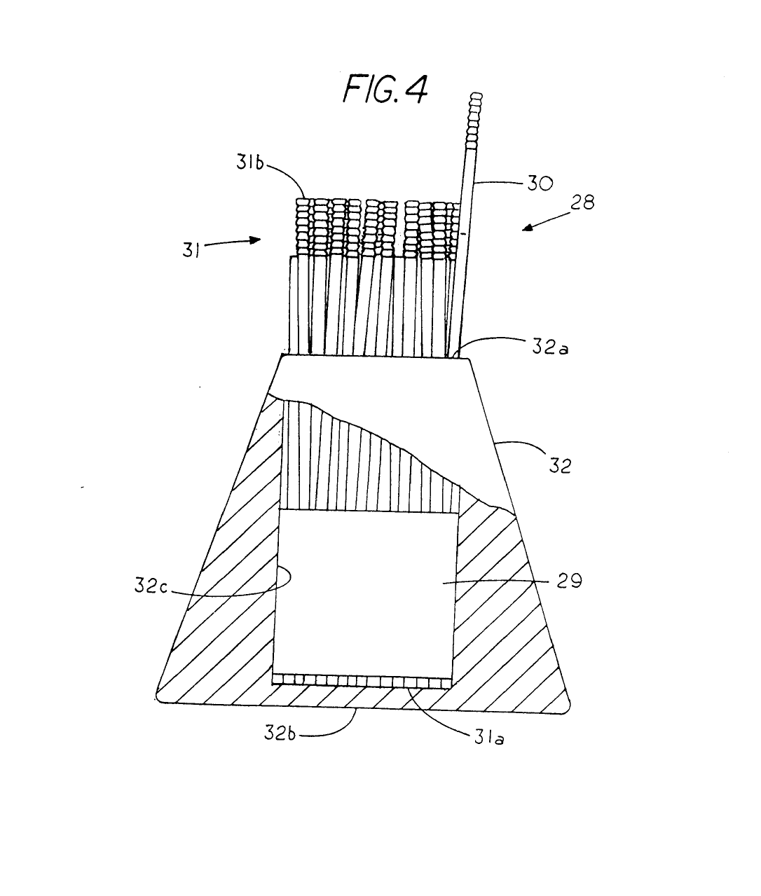

FIG. 3 is a partial cross-section side view showing an alternative embodiment of a drinking straw dispensing assembly 22 of the present invention comprising a sleeve 23 supporting at least a portion of a plurality of individually wrapped drinking straws 25 proximal a first end 24a of the sanitized wrappers 24 therein with the sanitized wrappers 24 bounded to each other proximal their first ends 24a within sleeve 24.

Drinking straw dispensing assembly 22 also includes a dispensing apparatus 25 having an open end 25a, a closed end 25b, and an internal chamber 25c for supporting sleeve 23 and at least a portion of a plurality of individually wrapped drinking straws 25 proximal a first end 24a of the sanitized wrappers 24 therein.

The dispensing apparatus 25 of FIG. 3 is also shown to include a flexible and tilt-able elongated arm 26 connecting the closed end 25b of dispensing apparatus 25 to a weighted base 27 for supporting dispensing apparatus 25 on a support surface such as a table or countertop.

FIG. 4 is a partial cross-section side view showing an alternative embodiment of a drinking straw dispensing assembly 28 of the present invention comprising a sleeve 29 supporting at least a portion of a plurality of individually wrapped drinking straws 30 proximal a first end 31a of the sanitized wrappers 31 therein with the sanitized wrappers 31 bounded to each other proximal their first ends 31a within sleeve 29.

Drinking straw dispensing assembly 28 also a weighted dispensing apparatus 32 having an open end 32a, a closed end 32b and an internal chamber 32c for supporting sleeve 29 and at least a portion of a plurality of individually wrapped drinking straws 30 proximal a first end 31a of the sanitized wrappers 31 therein. The embodiment of FIG. 4 shows weighted dispensing apparatus 32 having a body that is tapers from close end 32b to the open end 32a of weighted dispensing apparatus 32 in order to provide increased stability and support to the weighted dispensing apparatus 32.

I claim:

1. A sanitary drinking straw dispenser, comprising:
a) a multiplicity of drinking straws, each straw loosely enclosed in a contamination protective straw covering of frangible material;
b) said covered straws closely stacked within a container with each covering fixedly bonded to the interior of said container and a fingertip section of each covered straw exposed at an opening in said container for grasping a covered straw to remove it from said container; and
c) the frangible covering separating from the bonded section when said fingertip section of a covered straw is grasped and the straw extracted from the container.

2. The sanitary drinking straw dispenser as described in claim 1 wherein the closely stacked bonded cover material remaining within said container when a straw is removed obstructs insertion of a replacement straw into said container.

3. The sanitary drinking straw dispenser as in claim 1 wherein the length of said fingertip section of each covered straw is defined by a circumferential tear line on the straw cover, which severs when the fingertip section is grasped and the straw removed.

4. The sanitary drinking straw dispenser as in claim 1 wherein the fingertip section of each covered straw within the container is visually identified.

5. The sanitary drinking straw dispenser as in claim 4 wherein the fingertip section is visually identified by color-coding.

6. The sanitary drinking straw dispensing assembly of claim 1 wherein said container comprises a dispensing container having a suction-cup based stand.

7. The sanitary drinking straw dispensing assembly of claim 1 wherein said container comprises a dispensing container supporting and dispensing said plurality of drinking straws at an angle condition with respect to a support surface.

8. The sanitary drinking straw dispensing assembly of claim 1 wherein said container comprises a sleeve fixedly supporting and maintaining said protective straw covering therein.

9. The sanitary drinking straw dispensing assembly of claim 8 including a dispensing apparatus having an open end, a closed end, and an internal chamber for supporting said sleeve and said protective straw covering therein, said dispensing apparatus including a flexible and tilt-able elongated arm connecting said closed end of said dispensing apparatus to a weighted base for supporting said dispensing apparatus on a support surface.

10. A sanitary drinking straw dispensing assembly comprising:
a plurality of drinking straws each enclosed in an individual sanitized wrapper to protect said straw free of dirt and contamination;
said sanitized wrappers each having a first end, a second end and a fingertip grasping tear-away section located proximal said second end of said sanitized wrappers; and
a container supporting at least a portion of said wrapped straws proximal said first end of said sanitized wrappers therein with said sanitized wrappers bounded to each other proximal said first end of said sanitized wrappers within said container.

11. The sanitary drinking straw dispensing assembly of claim 10 wherein said sanitized wrappers are composed of a frangible material.

12. The sanitary drinking straw dispensing assembly of claim 10 wherein said sanitized wrappers are composed of plastic and with each sanitized wrapper including perforations located proximal said second end to assist in the removal of said fingertip grasping tear-away section.

13. The sanitary drinking straw dispensing assembly of claim 10 wherein said fingertip grasping tear-away section of each of said sanitized wrappers comprises a different color than a remainder portion of said sanitized wrapper to provide users with a visual indicator of where to grasp the drinking straw for dispensing.

14. The sanitary drinking straw dispensing assembly of claim 10 wherein said container comprises a sleeve supporting at least a portion of said wrapped straws proximal said first end of said sanitized wrappers therein with said sanitized wrappers bounded to each other proximal said first end of said sanitized wrappers within said sleeve.

15. The sanitary drinking straw dispensing assembly of claim 14 including a weighted dispensing apparatus having an open end, a closed end and an internal chamber for supporting said sleeve and at least a portion of said wrapped straws proximal said first end of said sanitized wrappers therein.

16. The sanitary drinking straw dispensing assembly of claim 10 wherein said container comprises a dispensing container having a suction-cup based stand.

17. The sanitary drinking straw dispensing assembly of claim 10 wherein said container comprises a dispensing container supporting and dispensing said plurality of drinking straws at an angle condition with respect to a support surface.

18. The sanitary drinking straw dispensing assembly of claim 14 including a dispensing apparatus having an open end, a closed end, and an internal chamber for supporting said sleeve and at least a portion of said wrapped straws proximal said first end of said sanitized wrappers therein, said dispensing apparatus including a flexible and tilt-able elongated arm connecting said closed end of said dispensing apparatus to a weighted base for supporting said dispensing apparatus on a support surface.

19. A sanitary drinking straw dispensing assembly comprising:
a plurality of drinking straws each enclosed in an individual sanitized wrapper to protect said straw free of dirt and contamination;
said sanitized wrappers each having a first end, a second end and a fingertip grasping tear-away section located proximal said second end of said sanitized wrappers, said fingertip grasping tear-away section comprising a different color than a remainder section of said sanitized wrapper to provide users with a visual indicator of where to grasp the drinking straw for dispensing; and
a container supporting at least a portion of said wrapped straws proximal said first end of said sanitized wrappers therein with said sanitized wrappers bounded to each other proximal said first end of said sanitized wrappers within said container.

20. The sanitary drinking straw dispensing assembly of claim 19 wherein said sanitized wrappers are composed of plastic and with each sanitized wrapper including perforations located proximal said second end to assist in the removal of said fingertip grasping tear-away section.
